(19) United States
(12) Patent Application Publication
(10) Pub. No.: US 2020/0057959 A1
(43) Pub. Date: Feb. 20, 2020

(54) REDUCING INSTANCES OF INCLUSION OF DATA ASSOCIATED WITH HINDSIGHT BIAS IN A TRAINING SET OF DATA FOR A MACHINE LEARNING SYSTEM

(71) Applicant: salesforce.com, inc., San Francisco, CA (US)

(72) Inventors: Kevin Moore, San Francisco, CA (US); Leah McGuire, Redwood City, CA (US); Matvey Tovbin, San Carlos, CA (US); Mayukh Bhaowal, San Francisco, CA (US); Shubha Nabar, Sunnyvale, CA (US)

(21) Appl. No.: 16/264,659

(22) Filed: Jan. 31, 2019

Related U.S. Application Data
(60) Provisional application No. 62/764,666, filed on Aug. 15, 2018.

(51) Int. Cl. G06N 20/00

(52) U.S. Cl. CPC G06N 20/00

(57) ABSTRACT

Instances of data associated with hindsight bias in a training set of data for a machine learning system can be reduced. A first set of data, having a first set of fields, can be received. Data in a first field can be analyzed with respect to data in a second field corresponding to an event to be predicted. A result can be that the data in the first field is associated with hindsight bias. A second set of data, having a second set of fields, can be produced. The second set of fields can exclude the first field. One or more features associated with the second set of data can be generated. A third set of data, having the second set of fields and fields that correspond to the one or more features, can be produced. The training set of data can be produced using the third set of data.

### CROSS-REFERENCE TO RELATED APPLICATIONS

This application claims, under 35 U.S.C. § 119(e), the benefit of U.S. Provisional Application No. 62/764,666, filed Aug. 15, 2018, the disclosure of which is incorporated herein in its entirety by reference.

### BACKGROUND

A machine learning system can use one or more algorithms, statistical models, or both to produce, from a training set of data, a mathematical model that can predict an outcome of a future occurrence of an event. The outcome of the future occurrence of the event can be referred to as a label. A set of data can be received. The set of data can be organized as records. The records can have a set of fields. One field can correspond to an occurrence of the event. A set of records can be determined in which members of the set of records have a value for this field that is other than a null value. This value can represent the outcome of a past occurrence of the event. This set of records can be designated as a preliminary training set of data. Records other than this set of records can be designated as a scoring set of data. It can be possible that one or more fields, other than the field that corresponds to the occurrence of the event, are associated with data that are entered into the set of data after the outcome of a corresponding occurrence of the event is known. Such data can be associated with hindsight bias. A training set of data that includes data associated with hindsight bias can be referred to as having label leakage. Instances of inclusion of data associated with hindsight bias in the training set of data can reduce an accuracy of the mathematical model to predict the outcome of the future occurrence of the event.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementation of the disclosed subject matter. No attempt is made to show structural details in more detail than may be necessary for a fundamental understanding of the disclosed subject matter and the various ways in which it can be practiced.

FIG. 1 is a diagram illustrating an example of an environment for producing a training set of data for a machine learning system, according to the disclosed technologies.

FIGS. 2A through 2C are a flow diagram illustrating an example of a method for reducing instances of inclusion of data associated with hindsight bias in a training set of data for a machine learning system, according to the disclosed technologies.

FIG. 3 is a diagram illustrating an example of a first set of data.

FIG. 4 is a flow diagram illustrating a first example of a method for performing an analysis of data in a first field with respect to data in a second field, according to the disclosed technologies.

FIG. 5 is a flow diagram illustrating a second example of a method for performing the analysis of the data in the first field with respect to the data in the second field, according to the disclosed technologies.

FIG. 6 is a flow diagram illustrating a third example of a method for performing the analysis of the data in the first field with respect to the data in the second field, according to the disclosed technologies.

FIG. 7 is a flow diagram illustrating a fourth example of a method for performing the analysis of the data in the first field with respect to the data in the second field, according to the disclosed technologies.

FIG. 8 is a flow diagram illustrating a fifth example of a method for performing the analysis of the data in the first field with respect to the data in the second field, according to the disclosed technologies.

FIG. 9 is a flow diagram illustrating a sixth example of a method for performing the analysis of the data in the first field with respect to the data in the second field, according to the disclosed technologies.

FIG. 10 is a flow diagram illustrating a seventh example of a method for performing the analysis of the data in the first field with respect to the data in the second field, according to the disclosed technologies.

FIG. 11 is a flow diagram illustrating an eighth example of a method for performing the analysis of the data in the first field with respect to the data in the second field, according to the disclosed technologies.

FIG. 12 is a flow diagram illustrating a ninth example of a method for performing the analysis of the data in the first field with respect to the data in the second field, according to the disclosed technologies.

FIG. 13 is a flow diagram illustrating a tenth example of a method for performing the analysis of the data in the first field with respect to the data in the second field, according to the disclosed technologies.

FIG. 14 is a flow diagram illustrating a eleventh example of a method for performing the analysis of the data in the first field with respect to the data in the second field, according to the disclosed technologies.

FIG. 15 is a diagram illustrating an example of a second set of data, according to the disclosed technologies.

FIG. 16 is a diagram illustrating an example of a third set of data, according to the disclosed technologies.

FIG. 17 is a diagram illustrating an example of the training set of data.

FIG. 18 is a graph illustrating an example of a set of iterations of actual outcomes of occurrences of an event.

FIG. 19 is a diagram illustrating an example of a conventional third set of data.

FIG. 20 is a block diagram of an example of a computing device suitable for implementing certain devices, according to the disclosed technologies.

### DETAILED DESCRIPTION

As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation.

A machine learning system can use one or more algorithms, statistical models, or both to produce, from a training set of data, a mathematical model that can predict an outcome of a future occurrence of an event. The outcome of the future occurrence of the event can be referred to as a label. A set of data can be received. The set of data can be organized as records. The records can have a set of fields. One field can correspond to an occurrence of the event. A set of records can be determined in which members of the set of records have a value for this field that is other than a null value. This value can represent the outcome of a past occurrence of the event. This set of records can be designated as a preliminary training set of data. Records other than this set of records can be designated as a scoring set of data. It can be possible that one or more fields, other than the field that corresponds to the occurrence of the event, are associated with data that are entered into the set of data after the outcome of a corresponding occurrence of the event is known. Such data can be associated with hindsight bias. A training set of data that includes data associated with hindsight bias can be referred to as having label leakage. Instances of inclusion of data associated with hindsight bias in the training set of data can reduce an accuracy of the mathematical model to predict the outcome of the future occurrence of the event.

The disclosed technologies can reduce instances of inclusion of data associated with hindsight bias in a training set of data for a machine learning system. A first set of data can be received. The first set of data can be organized as records. The records can have a first set of fields. An analysis of data in a first field of the first set of fields can be performed with respect to data in a second field of the first set of fields. The second field can correspond to an occurrence of an event. A result of the analysis can be determined. The result can be that the data in the first field is associated with hindsight bias. In responses to the result, a second set of data can be produced. The second set of data can be organized as the records. The records can have a second set of fields. The second set of fields can include the first set of fields except the first field. In response to a production of the second set of data, one or more features associated with the second set of data can be produced. In response to a generation of the one or more features, a third set of data can be produced. The third set of data can be organized as the records. The records having a third set of fields. The third set of fields can include the second set of fields and one or more additional fields. The one or more additional fields can correspond to the one or more feature. Using the third set of data, the training set of data can be produced. Using the training set of data, the machine learning system can be caused to be trained to predict the outcome of a future occurrence of the event.

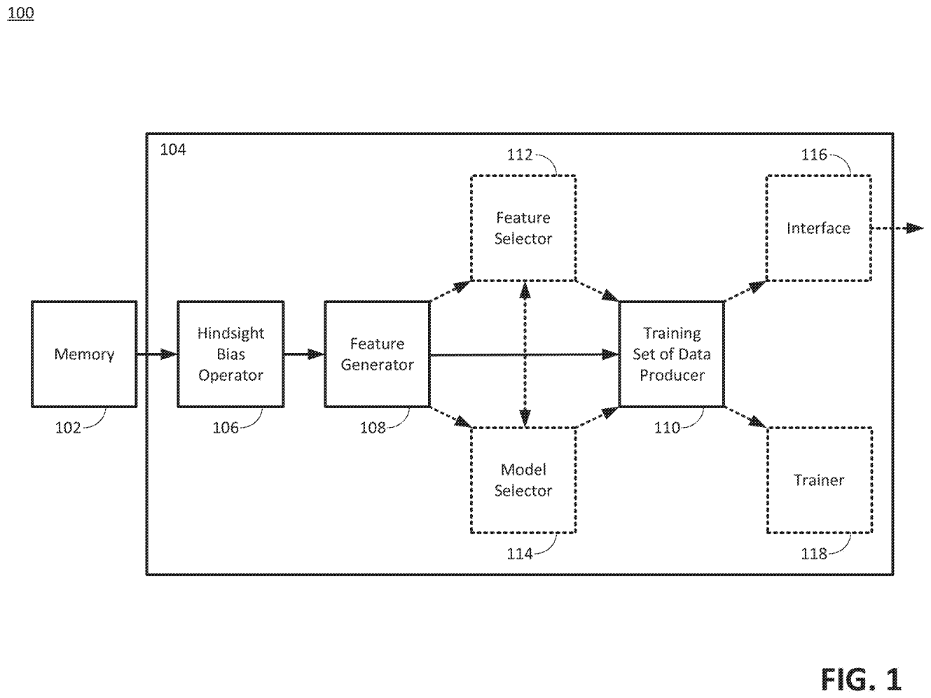

FIG. 1 is a diagram illustrating an example of an environment 100 for producing a training set of data for a machine learning system, according to the disclosed technologies. The environment 100 can include a memory 102 and a processor 104. The processor 104 can include, for example, a hindsight bias operator 106, a feature generator 108, and a training set of data producer 110.

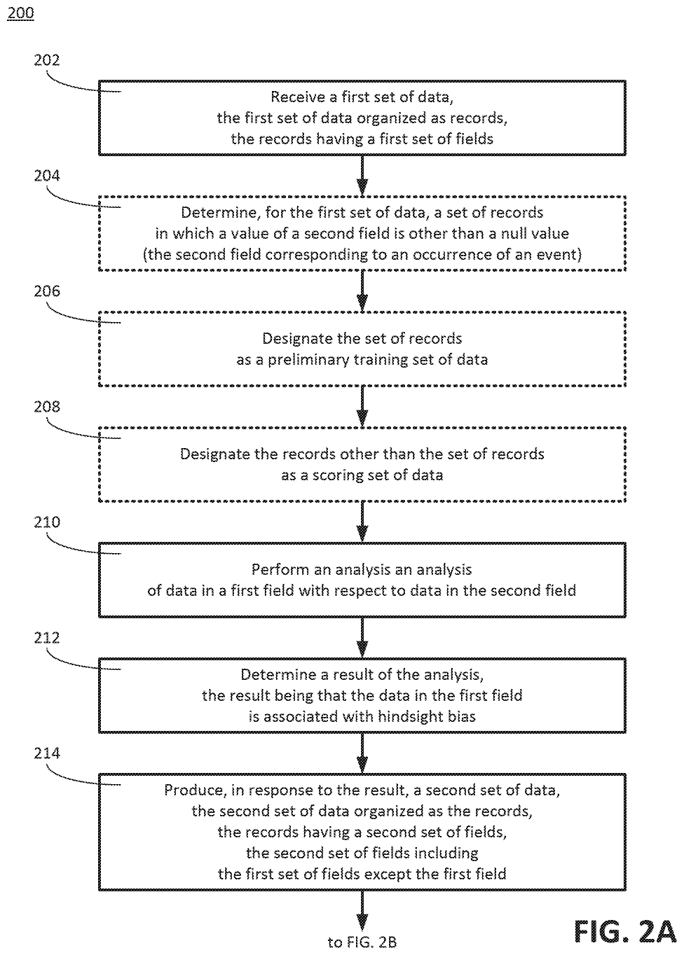

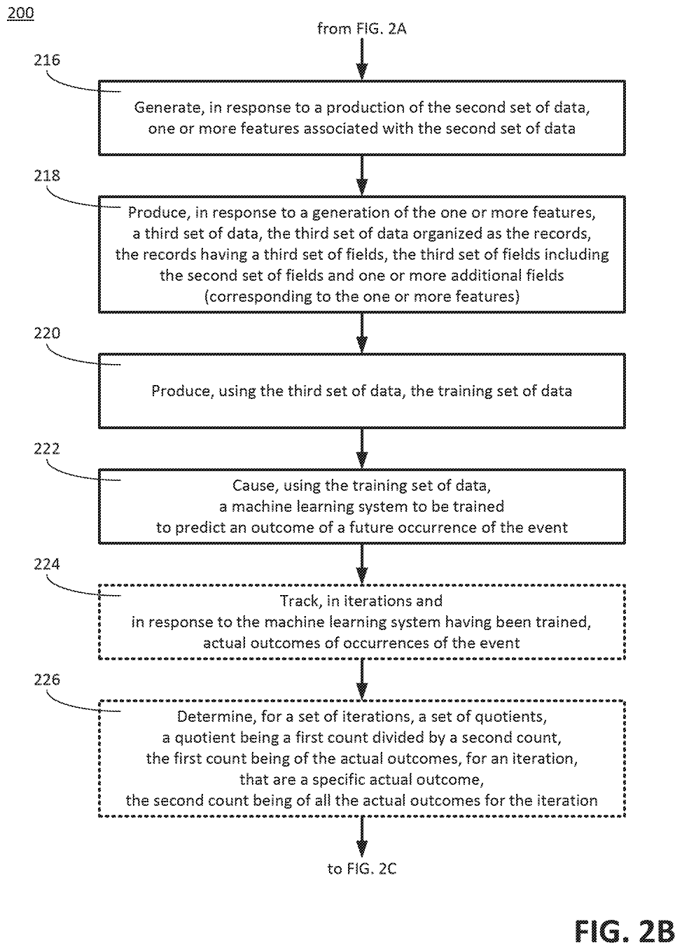

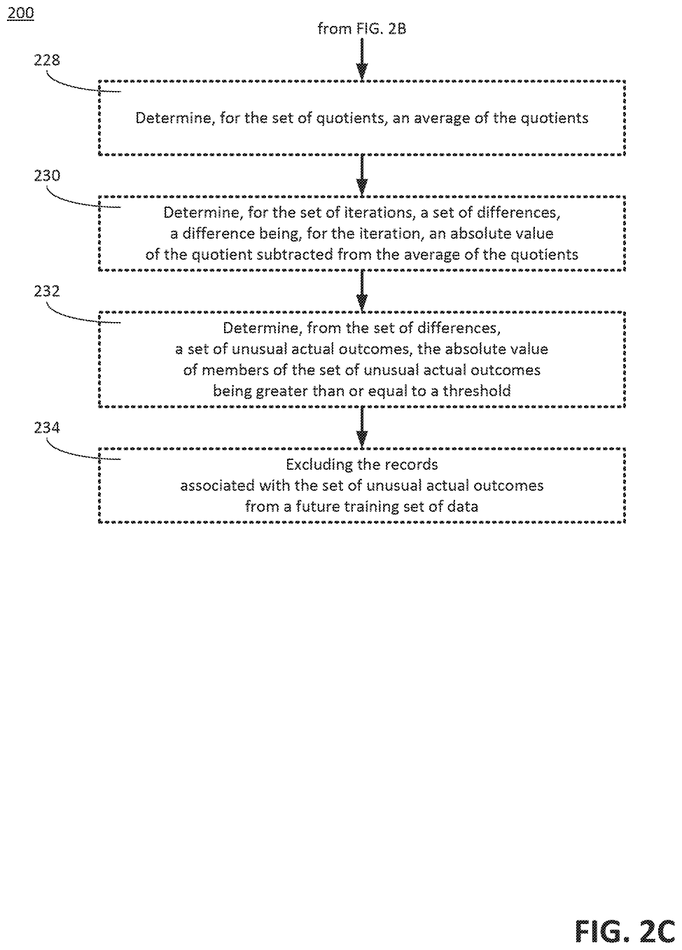

FIGS. 2A through 2C are a flow diagram illustrating an example of a method 200 for reducing instances of inclusion of data associated with hindsight bias in a training set of data for a machine learning system, according to the disclosed technologies.

With reference to FIG. 2A, in the method 200, at an operation 202, a first set of data can be received. The first set of data can be organized as records. The records can have a first set of fields.

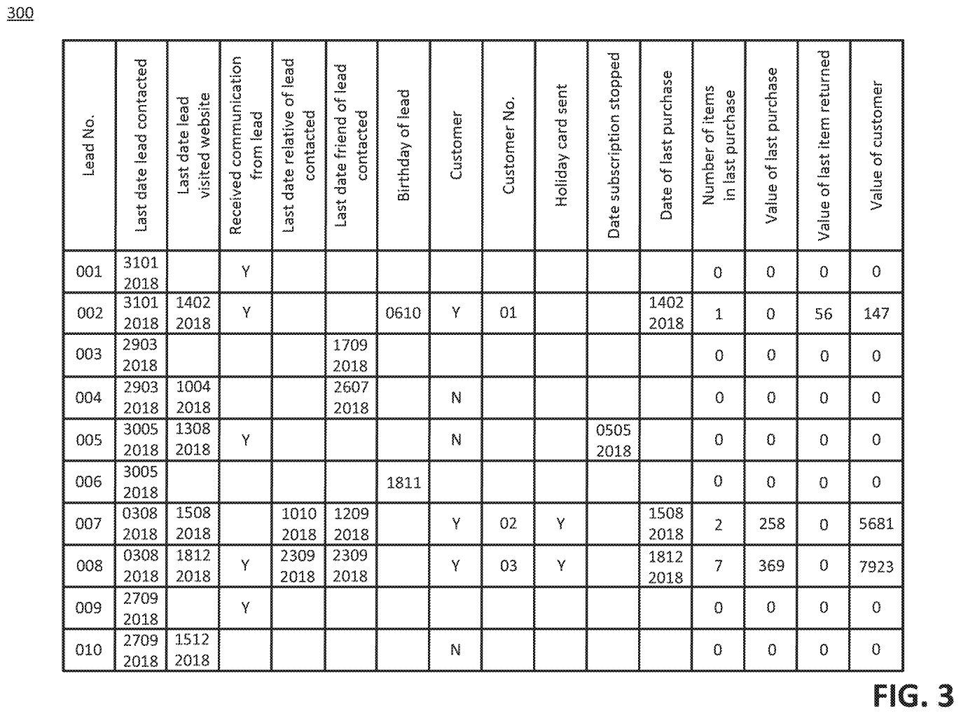

FIG. 3 is a diagram illustrating an example of a first set of data 300.

With reference to FIGS. 2A and 3, at an optional operation 204, for the first set of data 300, a first set of records can be determined. Members of the first set of records can have a value of a second field, of the first set of fields, that is other than a null value. The second field can correspond to an occurrence of an event. For example, the second field can be the Customer field for which an entry of data can be made in response to a determination about whether or not a lead has become a customer. For example, the first set of records can include records associated with Lead Nos. 002, 004, 005, 007, 008, and 010.

At an optional operation 206, a preliminary training set of data can be designated. The preliminary training set of data can include the first set of records. For example, the preliminary training set of records can include the records associated with Lead Nos. 002, 004, 005, 007, 008, and 010.

At an optional operation 208, a scoring set of data can be designated. The scoring set of data can include the records other than the first set of records. For example, the scoring set of records can include the records associated with Lead Nos. 001, 003, 006, and 009.

At an operation 210, an analysis of data in a first field, of the first set of fields, can be performed with respect to data in the second field.

At an operation 212, a result of the analysis can be determined. The result can be that the data in the first field is associated with hindsight bias.

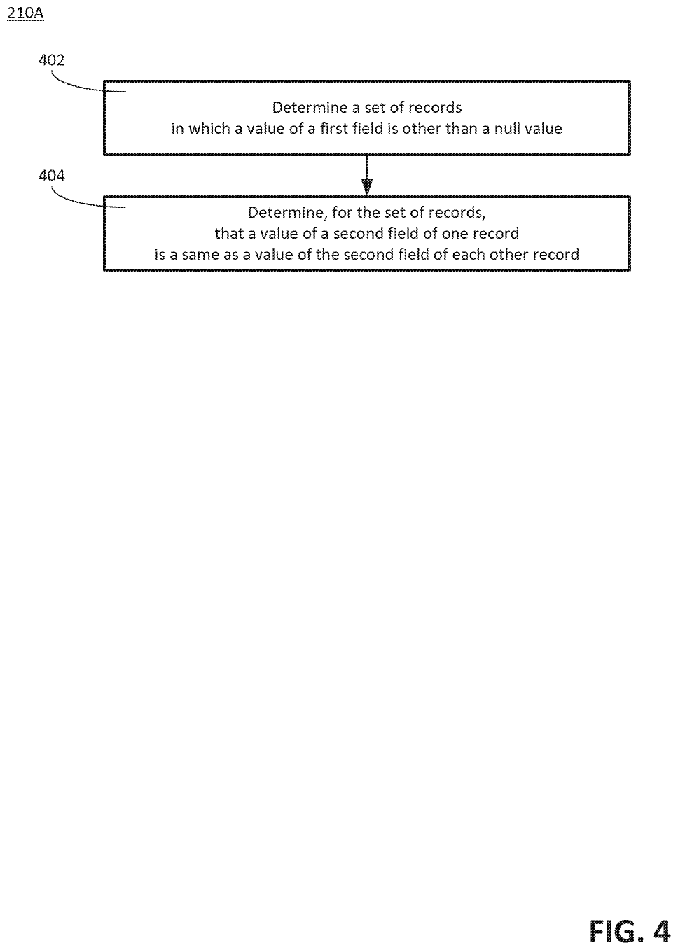

FIG. 4 is a flow diagram illustrating a first example of a method 210A for performing the analysis of the data in the first field with respect to the data in the second field, according to the disclosed technologies.

With reference to FIGS. 3 and 4, in the method 210A, at an operation 402, a second set of records can be determined. Members of the second set of records can have a value of the first field that is other than a null value.

At an operation 404, a determination can be made, for the second set of records, that a value of the second field of one record of the second set of records is a same as a value of the second field of each other record of the second set of records.

For example, the second set of records can include the records associated with Lead Nos. 002, 007, and 008 in which the first field is Customer No. Alternatively, for example, the second set of records can include the records associated with Lead Nos. 002, 007, and 008 in which the first field is Date of last purchase.

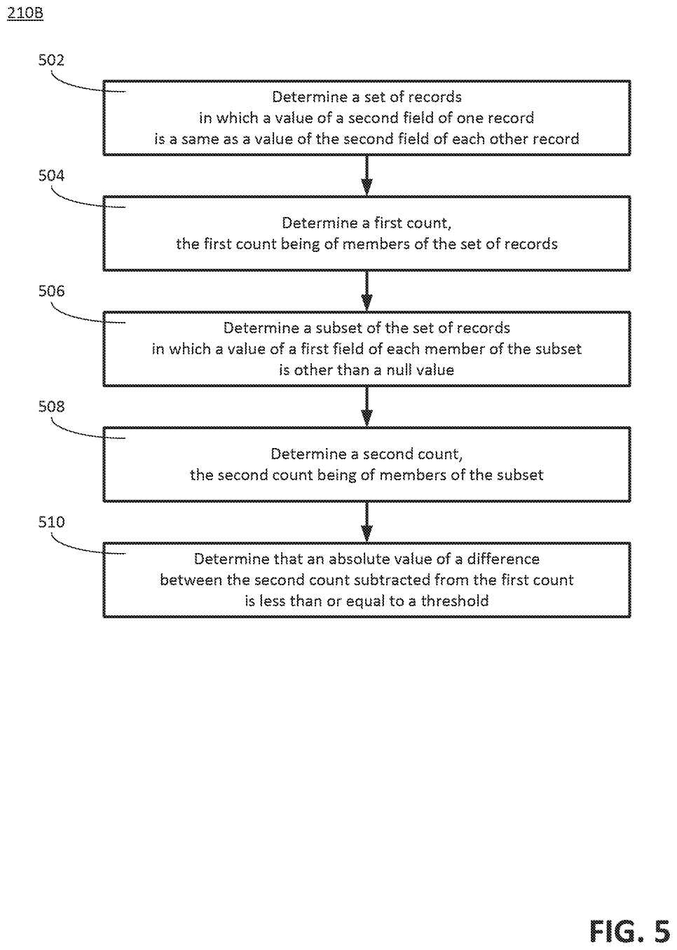

FIG. 5 is a flow diagram illustrating a second example of a method 210B for performing the analysis of the data in the first field with respect to the data in the second field, according to the disclosed technologies.

With reference to FIGS. 3 and 5, in the method 210B, at an operation 502, a third set of records can be determined. Members of the third set of records can have a value of the second field of one record of the third set of records that is a same as a value of the second field of each other record of the third set of records.

At an operation 504, a first count can be determined. The first count can be of the members of the third set of records.

At an operation 506, a subset of the third set of records can be determined. A value of the first field of each member of the subset of the third set of records can be other than a null value.

At an operation 508, a second count can be determined. The second count can be of members of the subset of the third set of records.

At an operation 510, a determination can be made that an absolute value of a difference between the second count subtracted from the first count is less than or equal to a threshold.

For example, if the threshold is one, then the third set of records can include the records associated with Lead Nos. 002, 007, and 008 in which the first field is Holiday card sent.

In general, a value of the threshold should not be too large so that the disclosed technologies can remove data associated with hindsight bias and not remove data having a predictive quality with respect to an outcome of a future occurrence of the event.

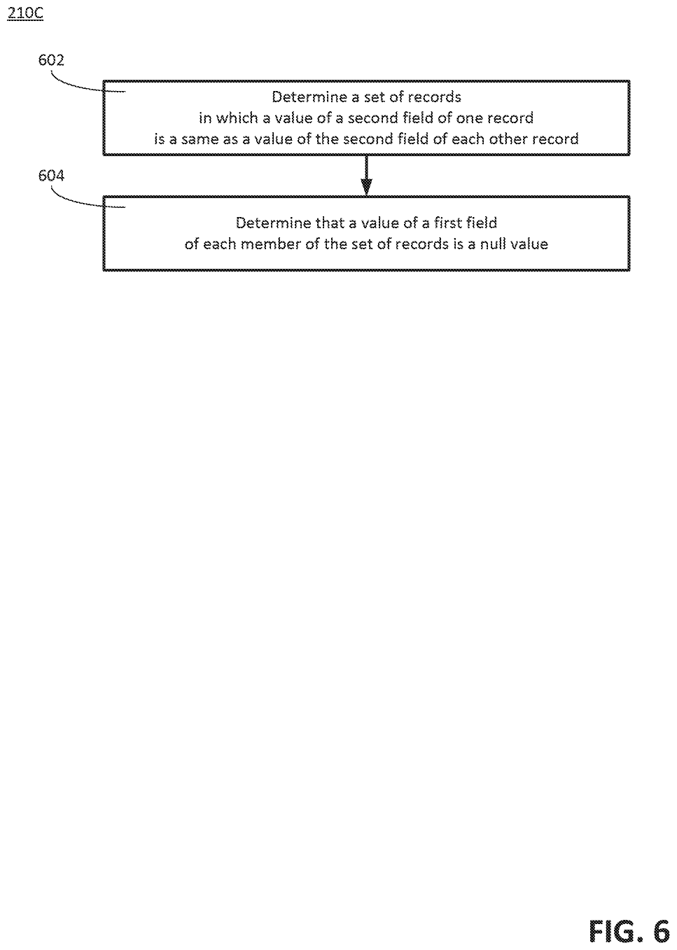

FIG. 6 is a flow diagram illustrating a third example of a method 210C for performing the analysis of the data in the first field with respect to the data in the second field, according to the disclosed technologies.

With reference to FIGS. 3 and 6, in the method 210C, at an operation 602, a fourth set of records can be determined. Members of the fourth set of records can have a value of the second field of one record of the fourth set of records that is a same as a value of the second field of each other record of the fourth set of records.

At an operation 604, a determination can be made that a value of the first field of each member of the fourth set of records is a null value.

For example, the fourth set of records can include the records associated with Lead Nos. 004, 005, and 010 in which the first field is Holiday card sent.

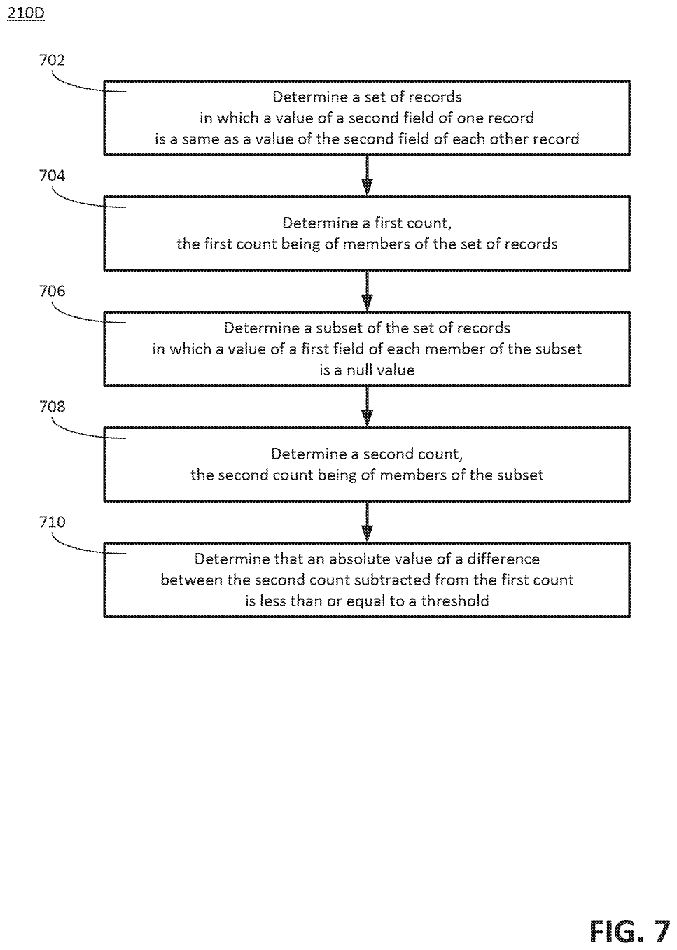

FIG. 7 is a flow diagram illustrating a fourth example of a method 210D for performing the analysis of the data in the first field with respect to the data in the second field, according to the disclosed technologies.

With reference to FIGS. 3 and 7, in the method 210D, at an operation 702, a fifth set of records can be determined. Members of the fifth set of records can have a value of the second field of one record of the fifth set of records that is a same as a value of the second field of each other record of the fifth set of records.

At an operation 704, a first count can be determined. The first count can be of the members of the fifth set of records.

At an operation 706, a subset of the fifth set of records can be determined. A value of the first field of each member of the subset of the fifth set of records can be a null value.

At an operation 708, a second count can be determined. The second count can be of members of the subset of the fifth set of records.

At an operation 710, a determination can be made that an absolute value of a difference between the second count subtracted from the first count is less than or equal to a threshold.

For example, if the threshold is one, then the fifth set of records can include the records associated with Lead Nos. 004, 005, and 010 in which the first field is Date subscription stopped.

In general, a value of the threshold should not be too large so that the disclosed technologies can remove data associated with hindsight bias and not remove data having a predictive quality with respect to an outcome of a future occurrence of the event.

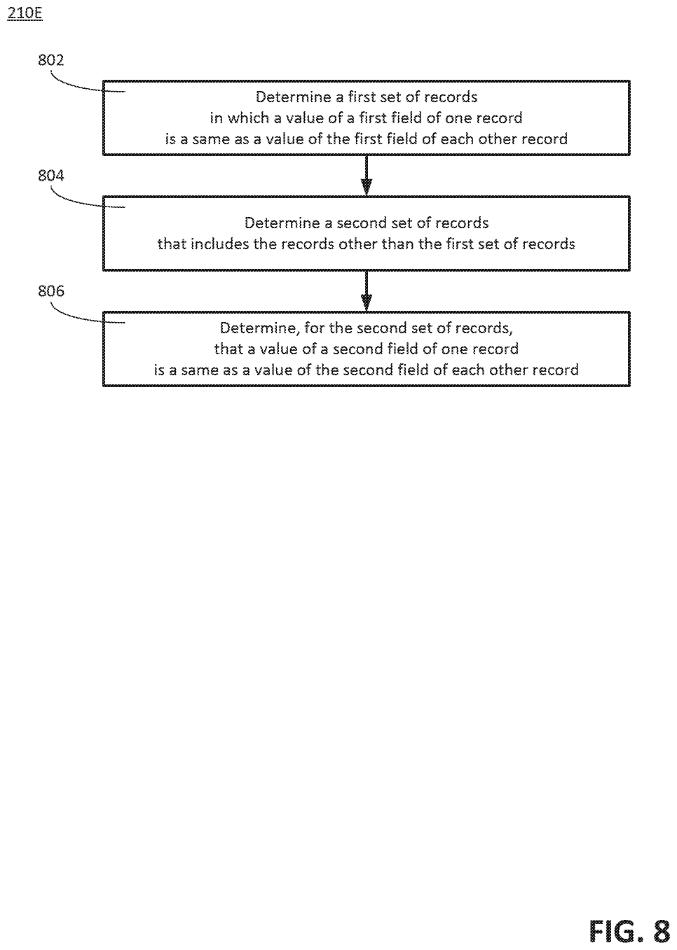

FIG. 8 is a flow diagram illustrating a fifth example of a method 210E for performing the analysis of the data in the first field with respect to the data in the second field, according to the disclosed technologies.

With reference to FIGS. 3 and 8, in the method 210E, at an operation 802, a sixth set of records can be determined. A value of the first field of one record of the sixth set of records can be a same as a value of the first field of each other record of the sixth set of records.

At an operation 804, a seventh set of records can be determined. The seventh set of records can be the records other than the sixth set of records.

At an operation 806, a determination can be made, for the seventh set of records, that a value of the second field of one record of the seventh set of records is a same as a value of the second field of each other record of the seventh set of records.

For example, the seventh set of records can include the records associated with Lead Nos. 002, 007, and 008 in which the first field is Value of customer.

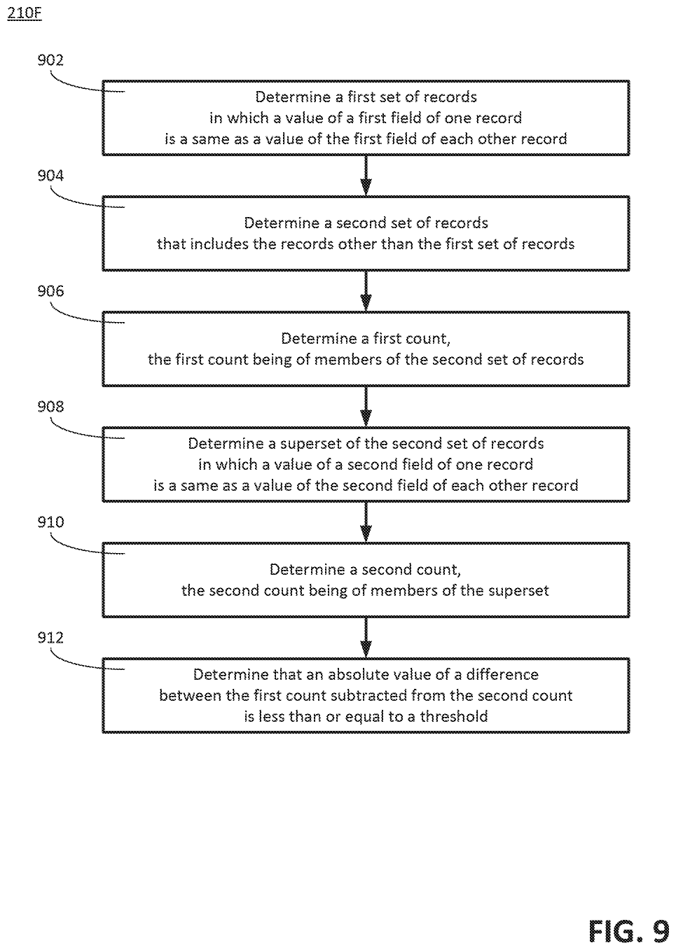

FIG. 9 is a flow diagram illustrating a sixth example of a method 210F for performing the analysis of the data in the first field with respect to the data in the second field, according to the disclosed technologies.

With reference to FIGS. 3 and 9, in the method 210F, at an operation 902, an eighth set of records can be determined. A value of the first field of one record of the eighth set of records can be a same as a value of the first field of each other record of the eighth set of records.

At an operation 904, a ninth set of records can be determined. The ninth set of records can be the records other than the eighth set of records.

At an operation 906, a first count can be determined. The first count can be of members of the ninth set of records.

At an operation 908, for the ninth set of records, a superset of the ninth set of records can be determined. A value of the second field of one record of the superset of the ninth set of records can be a same as a value of the second field of each other record of the superset of the ninth set of records.

At an operation 910, a second count can be determined. The second count can be of members of the superset of the ninth set of records.

At an operation 912, a determination can be made that an absolute value of a difference between the first count subtracted from the second count is less than or equal to a threshold.

For example, if the threshold is one, then the ninth set of records can include the records associated with Lead Nos. 002, 007, and 008 in which the first field is Value of last purchase. (For example, an entity associated with Lead No. 002 may have received a promotional offer such that a value of a last purchase by this entity was zero.)

In general, a value of the threshold should not be too large so that the disclosed technologies can remove data associated with hindsight bias and not remove data having a predictive quality with respect to an outcome of a future occurrence of the event.

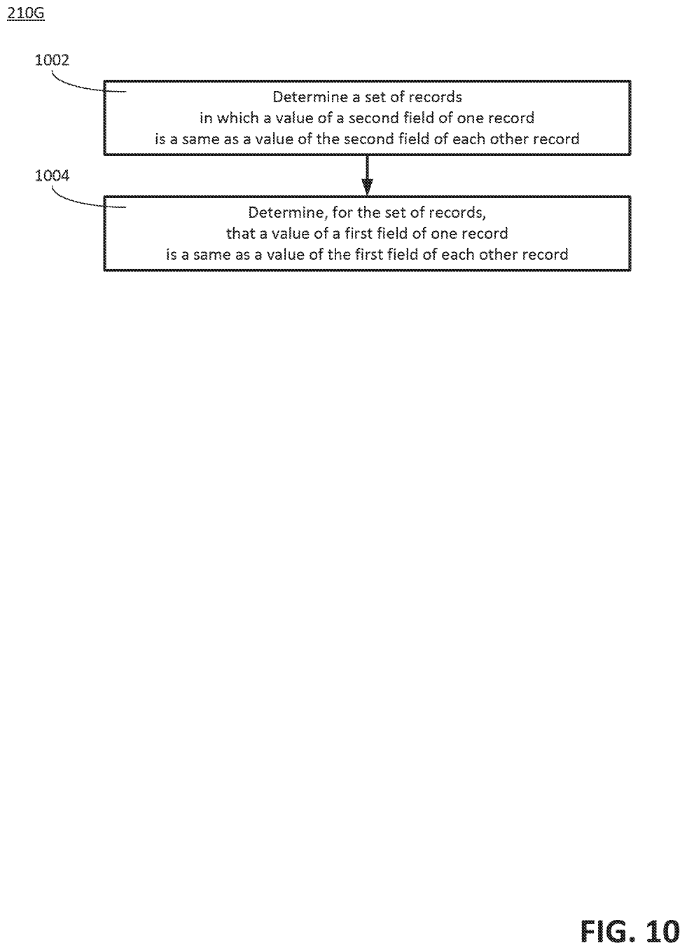

FIG. 10 is a flow diagram illustrating a seventh example of a method 210G for performing the analysis of the data in the first field with respect to the data in the second field, according to the disclosed technologies.

With reference to FIGS. 3 and 10, in the method 210G, at an operation 1002, a tenth set of records can be determined. Members of the tenth set of records can have a value of the second field of one record of the tenth set of records that is a same as a value of the second field of each other record of the tenth set of records.

At an operation 1004, a determination can be made, for the tenth set of records, that a value of the first field of one record of the tenth set of records that is a same as a value of the first field of each other record of the tenth set of records.

For example, the tenth set of records can include the records associated with Lead Nos. 004, 005, and 010 in which the first field is Number of items in last purchase.

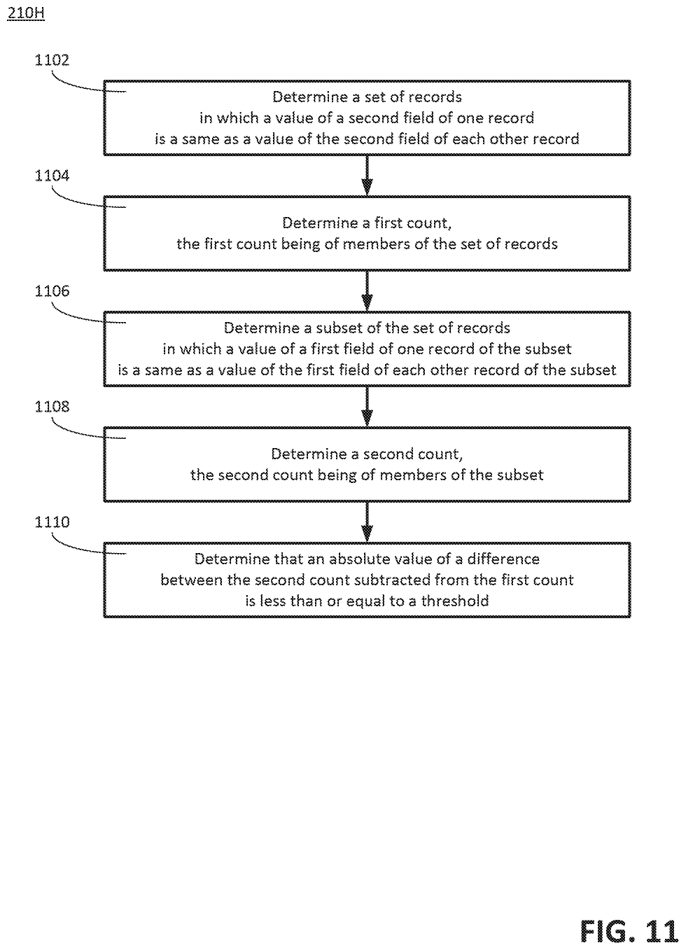

FIG. 11 is a flow diagram illustrating an eighth example of a method 210H for performing the analysis of the data in the first field with respect to the data in the second field, according to the disclosed technologies.

With reference to FIGS. 3 and 11, in the method 210H, at an operation 1102, an eleventh set of records can be determined. Members of the eleventh set of records can have a value of the second field of one record of the eleventh set of records that is a same as a value of the second field of each other record of the eleventh set of records.

At an operation 1104, a first count can be determined. The first count can be of the members of the eleventh set of records.

At an operation 1106, for the eleventh set of records, a subset of the eleventh set of records can be determined. A value of the first field of one record of the subset of the eleventh set of records can be a same as a value of the first field of each other record of the subset of the eleventh set of records.

At an operation 1108, a second count can be determined. The second count can be of members of the subset of the eleventh set of records.

At an operation 1110, a determination can be made that an absolute value of a difference between the second count subtracted from the first count is less than or equal to a threshold.

For example, if the threshold is one, then the eleventh set of records can include the records associated with Lead Nos. 002, 007, and 008 in which the first field is Value of last item returned.

In general, a value of the threshold should not be too large so that the disclosed technologies can remove data associated with hindsight bias and not remove data having a predictive quality with respect to an outcome of a future occurrence of the event.

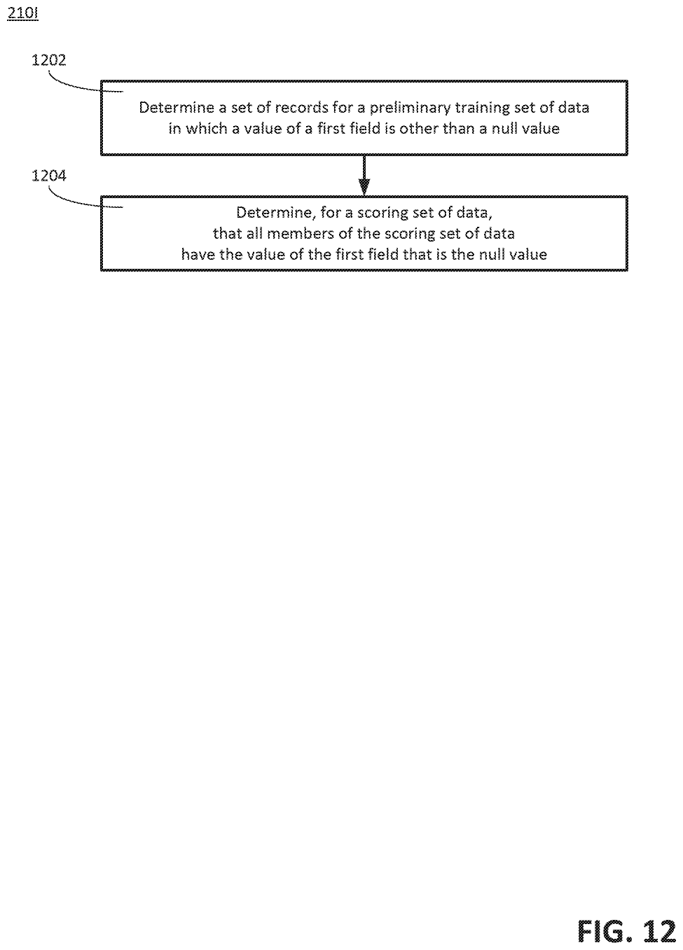

FIG. 12 is a flow diagram illustrating a ninth example of a method 2101 for performing the analysis of the data in the first field with respect to the data in the second field, according to the disclosed technologies.

With reference to FIGS. 3 and 12, in the method 2101, at an operation 1202, a twelfth set of records can be determined for the preliminary training set of data. Members of the twelfth set of records can have a value of the first field that is other than a null value.

At an operation 1204, a determination can be made, for the scoring set of data, that all of the members of the scoring set of data have the value of the first field that is the null value.

For example, the twelfth set of records can include the records associated with Lead Nos. 007 and 008 in which the first field is Last date relative of lead contacted.

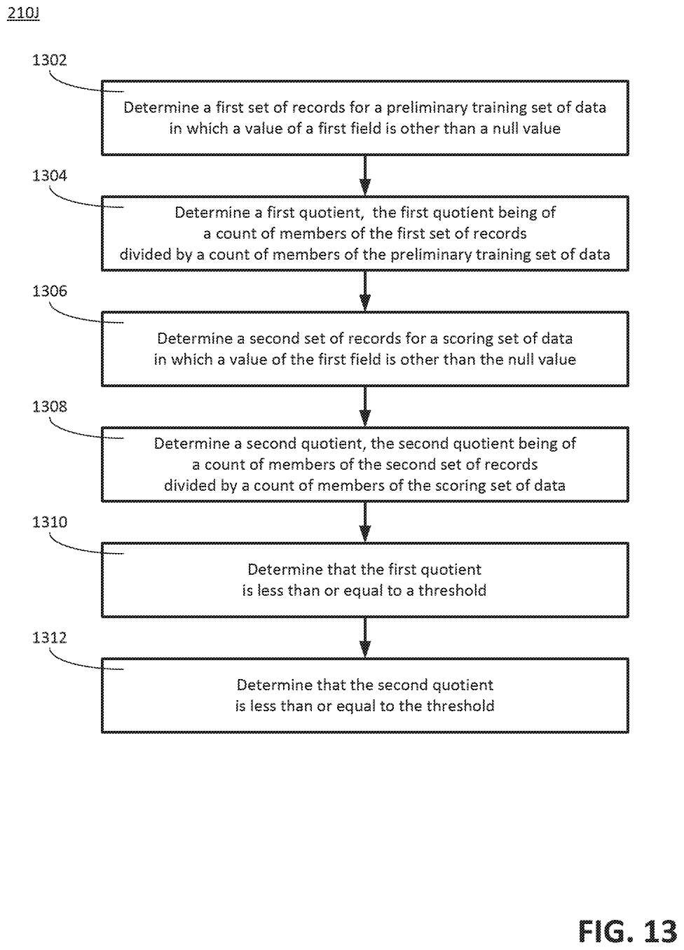

FIG. 13 is a flow diagram illustrating a tenth example of a method 210J for performing the analysis of the data in the first field with respect to the data in the second field, according to the disclosed technologies.

With reference to FIGS. 3 and 13, in the method 210J, at an operation 1302, a thirteenth set of records can be determined for the preliminary training set of data. Members of the thirteenth set of records can have a value of the first field that is other than a null value.

At an operation 1304, a first quotient can be determined. The first quotient can be of a count of the members of the thirteenth set of records divided by a count of members of the preliminary training set of data.

At an operation 1306, a fourteenth set of records can be determined for the scoring set of data. Members of the fourteenth set of records can have the value of the first field that is other than the null value.

At an operation 1308, a second quotient can be determined. The second quotient can be of a count of the members of the fourteenth set of records divided by a count of the members the scoring set of data.

At an operation 1310, a determination can be made that the first quotient is less than or equal to a threshold.

At an operation 1312, a determination can be made that the second quotient is less than or equal to the threshold.

For example, if the threshold is 0.25 and the first field is Birthday of lead, then the thirteenth set of records can include the record associated with Lead No. 002, the first quotient can be 0.1667, the fourteenth set of records can include the record associated with Lead No. 006, and the second quotient can be 0.25.

In general, a value of the threshold should not be too large so that the disclosed technologies can remove data associated with hindsight bias and not remove data having a predictive quality with respect to an outcome of a future occurrence of the event.

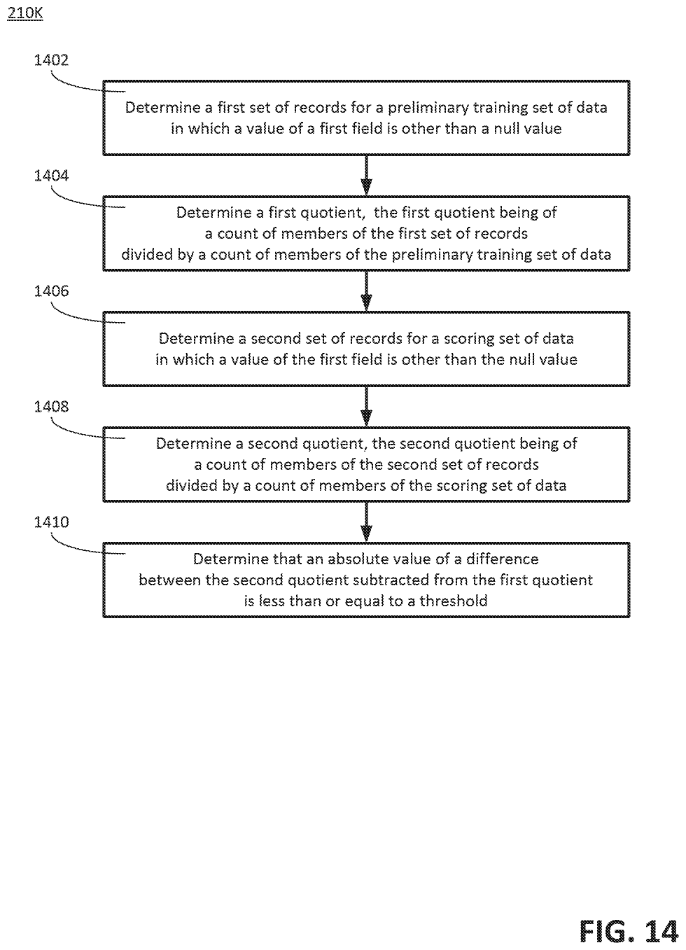

FIG. 14 is a flow diagram illustrating an eleventh example of a method 210K for performing the analysis of the data in the first field with respect to the data in the second field, according to the disclosed technologies.

With reference to FIGS. 3 and 14, in the method 210K, at an operation 1402, a fifteenth set of records can be determined for the preliminary training set of data. Members of the fifteenth set of records can have a value of the first field that is other than a null value.

At an operation 1404, a first quotient can be determined. The first quotient can be of a count of the members of the fifteenth set of records divided by a count of members of the preliminary training set of data.

At an operation 1406, a sixteenth set of records can be determined for the scoring set of data. Members of the sixteenth set of records can have the value of the first field that is other than the null value.

At an operation 1408, a second quotient can be determined. The second quotient can be of a count of the members of the sixteenth set of records divided by a count of the members the scoring set of data.

At an operation 1410, a determination can be made that an absolute value of a difference between the second quotient subtracted from the first quotient is greater than or equal to a threshold.

For example, if the threshold is 0.25 and the first field is Last date friend of lead contacted, then the fifteenth set of records can include the records associated with Lead Nos. 004, 007, and 008, the first quotient can be 0.5, the sixteenth set of records can include the record associated with Lead No. 003, and the second quotient can be 0.25.

In general, a value of the threshold should not be too small so that the disclosed technologies can remove data associated with hindsight bias and not remove data having a predictive quality with respect to an outcome of a future occurrence of the event.

Returning to FIG. 2A, in the method 200, at an operation 214, a second set of data can be produced in response to the result. The second set of data can be organized as the records. The records can have a second set of fields. The second set of fields can includes the first set of fields except the first field(s).

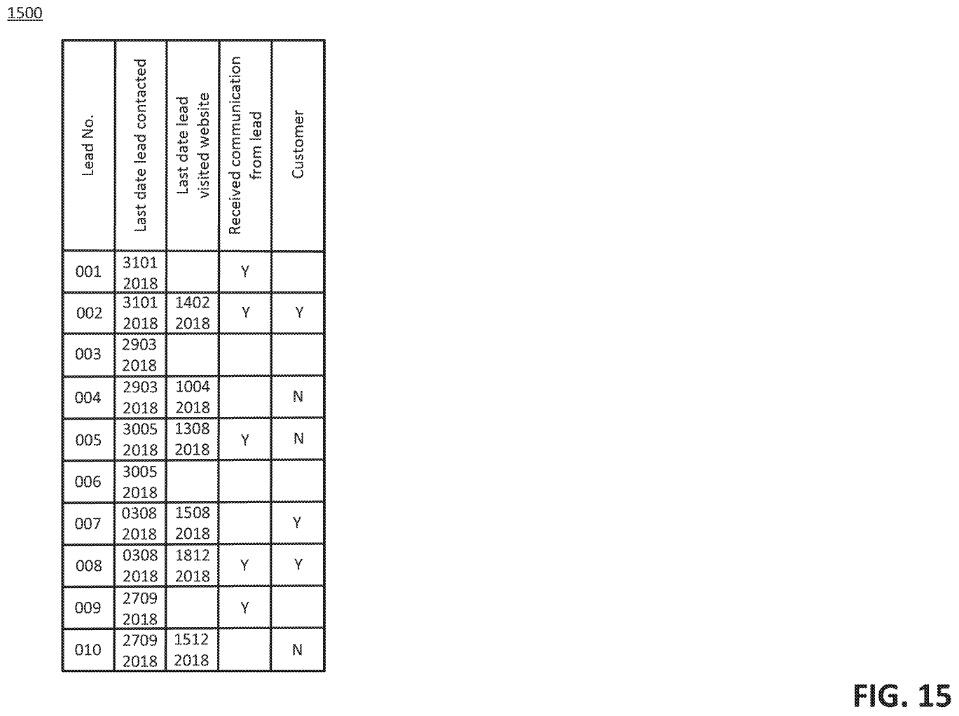

FIG. 15 is a diagram illustrating an example of a second set of data 1500, according to the disclosed technologies.

With reference to FIG. 2B, in the method 200, at an operation 216, one or more features associated with the second set of data can be generated in response to a production of the second set of data. The one or more features can be generated by one or more of feature engineering, feature extraction, or feature learning. Feature engineering can be a process, performed by a data scientist, of using domain knowledge about a subject for which the machine learning system is to be trained to produce the one or more features. The one or more features can be derived from the second set of data, can characterize one or more relationships among one or more items of data included in the second set of data, and can be formatted to be one or more inputs for the machine learning system. Feature engineering can be differentiated from feature extraction in that feature engineering is performed on items of data that can be used as one or more inputs for the machine learning system. Feature extraction can be a process performed on data that may not be able to be used as inputs for the machine learning system. For example, if the data are an image, then feature extraction can be used to derive characteristics of the image that can be used as inputs for the machine learning system. Feature learning can refer to techniques used to derive automatically features that can be used as inputs for the machine learning system.

At an operation 218, a third set of data can be produced in response to a generation of the one or more features. The third set of data can be organized as the records. The records can have a third set of fields. The third set of fields can include the second set of fields and one or more additional fields. The one or more additional fields can corresponds to the one or more features.

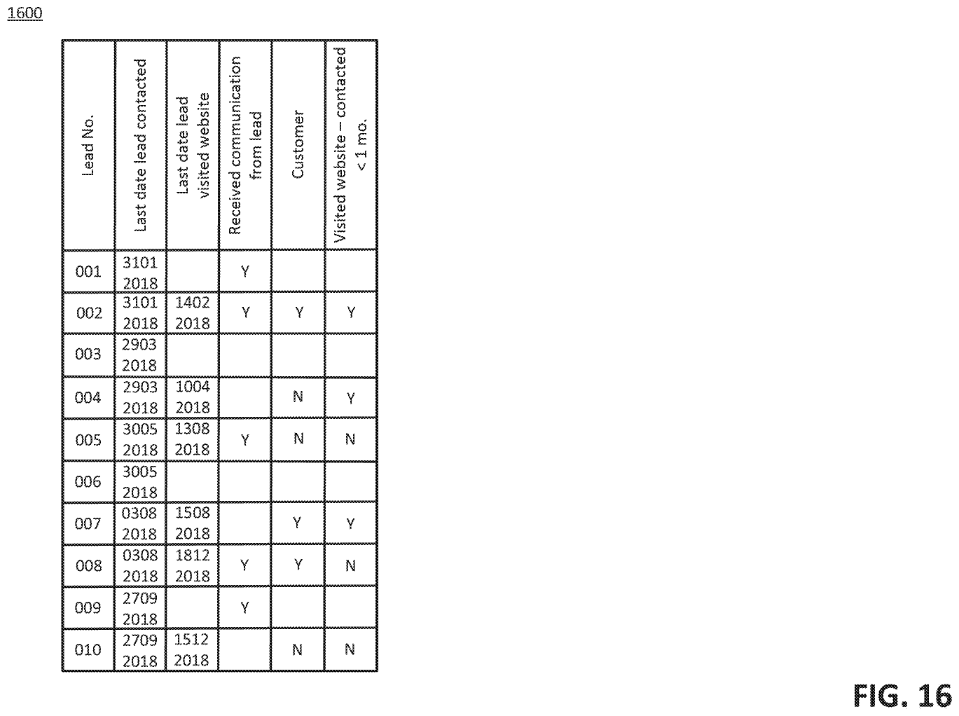

FIG. 16 is a diagram illustrating an example of a third set of data 1600, according to the disclosed technologies. As illustrated in FIG. 16, the third set of data 1600 can include the field Visited website—contacted <1 mo. For those records that include entries for both Last date lead contacted and Last date lead visited website, Visited website—contacted <1 mo. can have a Boolean entry of: (1) Y (yes) if a difference between these two dates is less than one month (e.g., 30 days) and (2) N (no) if the difference between these two dates is greater than or equal to one month.

Returning to FIG. 2B, in the method 200, at an operation 220, the training set of data can be produced using the third set of data. Optionally, the training set of data can be produced by one or more of: (1) selecting, from the third set of data, a set of features or (2) selecting a mathematical model for the machine learning system. Optionally, for example, with reference to FIG. 1, the processor 104 can include one or more of a feature selector 112 or a model selector 114.

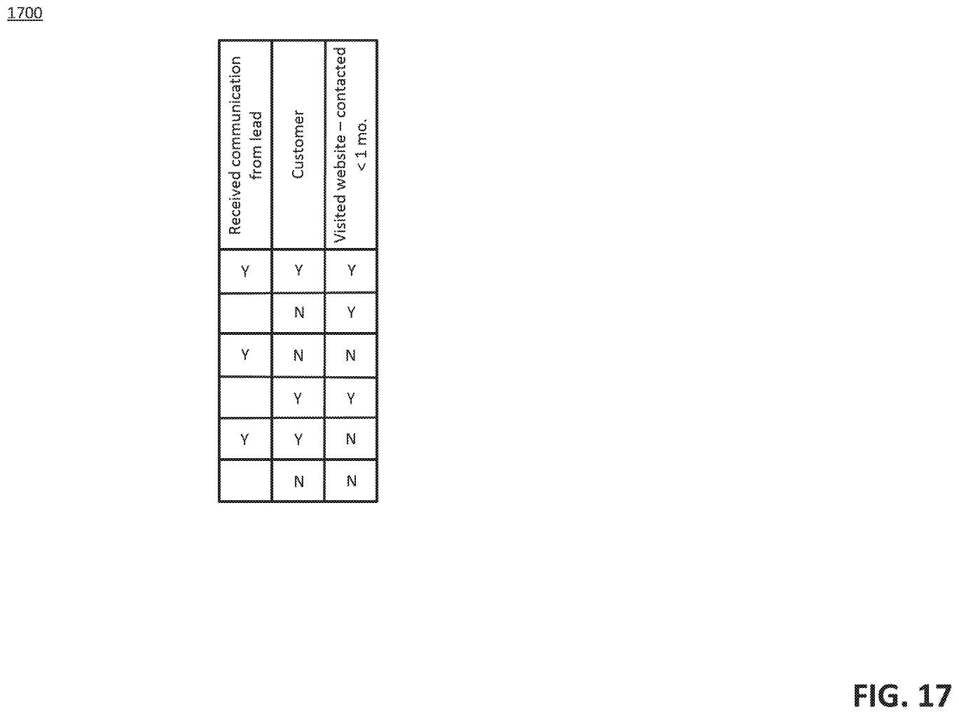

FIG. 17 is a diagram illustrating an example of the training set of data 1700. As illustrated in FIG. 17, the training set of data 1700 can include the records from the preliminary training set of data (i.e., the records associated with Lead Nos. 002, 004, 005, 007, 008, and 010) and data from the fields Received communication from the lead, Customer (i.e., the label), and Visited website—contacted <1 mo.

Returning to FIG. 2B, in the method 200, at an operation 222, the machine learning system can be caused, using the training set of data, to be trained to predict an outcome of a future occurrence of the event. Optionally, the machine learning system can be caused to be trained by conveying, to another processor, the training set of data. The training set of data can be used by the other processor to train the machine learning system to predict the outcome of the future occurrence of the event. For example, with reference to FIG. 1, the processor 104 can include an interface 116. Optionally, additionally or alternatively, the machine learning system can be caused to be trained by training, using the training set of data, the machine learning system to predict the outcome of the future occurrence of the event. For example, with reference to FIG. 1, the processor 104 can include a trainer 118.

Training the machine learning system can be a continual process.

For example, returning to FIG. 2B, in the method 200, at an optional operation 224, in response to the machine learning system having been trained, actual outcomes of occurrences of the event can be tracked in iterations.

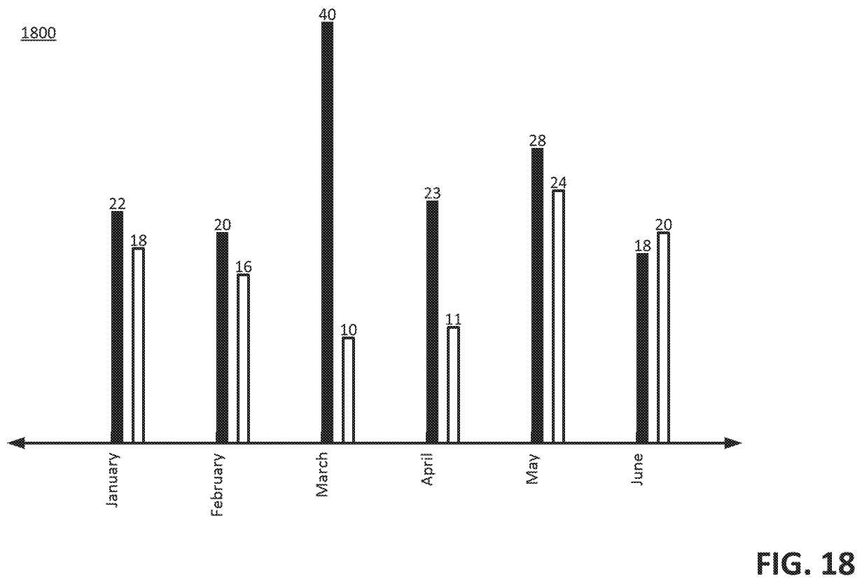

FIG. 18 is a graph 1800 illustrating an example of a set of iterations of actual outcomes of occurrences of an event. For example, the graph 1800 illustrates that during the January iteration, 22 leads became customers, but 18 leads did not become customers; during the February iteration, 20 leads became customers, but 16 leads did not become customers; during the March iteration, 40 leads became customers, but 10 leads did not become customers; during the April iteration, 23 leads became customers, but 11 leads did not become customers; during the May iteration, 28 leads became customers, but 24 leads did not become customers; and during the June iteration, 18 leads became customers, but 20 leads did not become customers.

Returning to FIG. 2B, in the method 200, at an optional operation 226, a set of quotients can be determined for a set of iterations. A quotient, of the set of quotients, can be a first count divided by a second count. The first count can be of the actual outcomes, for an iteration of the set of iterations, that are a specific actual outcome. The second count can be of all the actual outcomes for the iteration. For example, with reference to FIG. 18, for the January iteration, the quotient can be 22/40 (0.55); for the February iteration, the quotient can be 20/36 (0.56); for the March iteration, the quotient can be 40/50 (0.80); for the April iteration, the quotient can be 23/44 (0.53); for the May iteration, the quotient can be 28/52 (0.54); and for the June iteration, the quotient can be 18/38 (0.47).

With reference to FIG. 2C, at an optional operation 228, for the set of quotients, an average of the quotients can be determined. For example, the average of the quotients can be (22+20+40+23+28+18)/(40+36+50+44+52+38)=0.58.

At an optional operation 230, for the set of iterations, a set of difference can be determined. A difference, of the set of differences, can be, for the iteration, an absolute value of the quotient subtracted from the average of the quotients. For example, for the January iteration, the difference can be 0.03; for the February iteration, the difference can be 0.02; for the March iteration, the difference can be 0.22; for the April iteration, the difference can be 0.05; for the May iteration, the difference can be 0.04; and for the June iteration, the difference can be 0.11.

At an optional operation 232, from the set of differences, a set of unusual actual outcomes can be determined. The absolute value of members of the set of unusual actual outcomes can be greater than or equal to a threshold. For example, if the threshold is 0.15, then the set of unusual actual outcomes can include the actual outcomes for the March iteration.

At an optional operation 234, the records associated with the set of unusual actual outcomes can be excluded from a future training set of data.

Advantageously, the disclosed technologies can automate operations associated with training a machine learning system that conventionally have not been automated. Specifically, although conventional technologies include a variety of automated techniques associated with feature engineering, feature selection, and mathematical models, conventionally a data scientist must manually select from among this variety of automated techniques. In contrast, the disclosed technologies provide for automatic selection of feature engineering techniques, feature selection techniques, and mathematical models. Thus, the disclosed technologies integrate automation of operations associated with training a machine learning system.

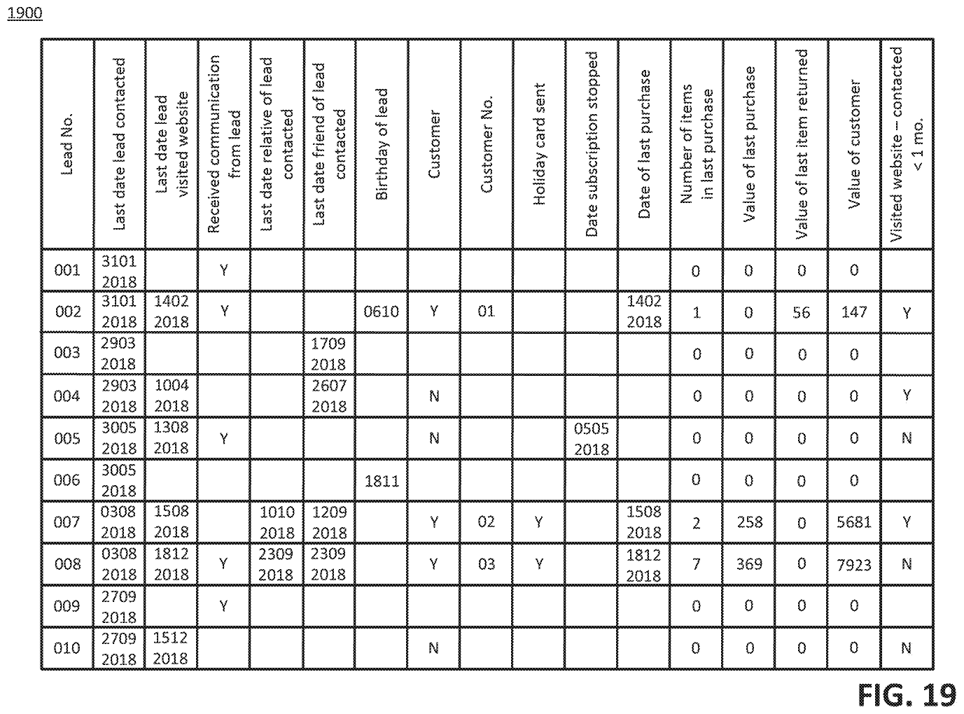

Advantageously, the disclosed technologies use a fewer number of memory cells than conventional approaches to producing the training set of data. FIG. 19 is a diagram illustrating an example of a conventional third set of data 1900. The conventional third set of data can be organized as the records. The records can have a conventional set of fields. The conventional set of fields can include the first set of fields (see FIG. 3) and the one or more additional fields for the one or more features (see FIG. 16). The conventional third set of data can use a first number of memory cells (see FIG. 19). The third set of data, according the disclosed technologies, can use a second number of memory cells (see FIG. 16). The second number can be less than the first number. Moreover, an actual implementation of the conventional third set of data can include more memory cells than illustrated in FIG. 19 because one or more features likely would be generated for fields not included in the third set of data, according to the disclosed technologies. An actual implementation of operations to train a machine learning system can involve hundreds of fields for which thousands of features can be generated. Furthermore, the approach used by the disclosed technologies is contrary to the conventional practice taught to data scientists to preserve fields for inclusion in the mathematical model.

In light of the technologies described above, one of skill in the art understands that reducing instances of inclusion of data associated with hindsight bias in a training set of data for a machine learning system can include any combination of some or all of the foregoing configurations.

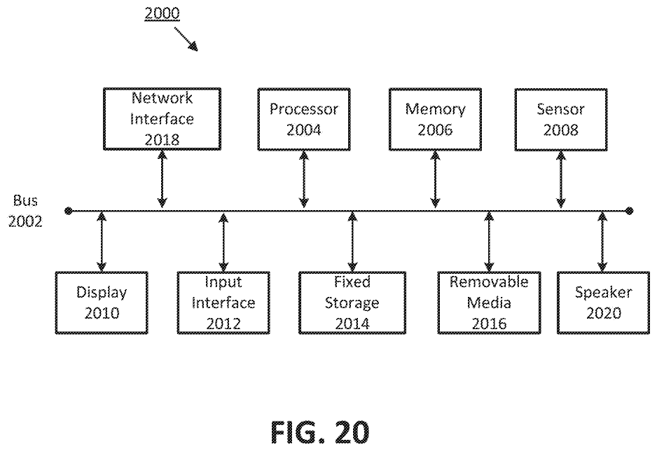

FIG. 20 is a block diagram of an example of a computing device 2000 suitable for implementing certain devices, according to the disclosed technologies. The computing device 2000 can be constructed as a custom-designed device or can be, for example, a special-purpose desktop computer, laptop computer, or mobile computing device such as a smart phone, tablet, personal data assistant, wearable technology, or the like.

The computing device 2000 can include a bus 2002 that interconnects major components of the computing device 2000. Such components can include a central processor 2004, a memory 2006 (such as Random Access Memory (RAM), Read-Only Memory (ROM), flash RAM, or the like), a sensor 2008 (which can include one or more sensors), a display 2010 (such as a display screen), an input interface 2012 (which can include one or more input devices such as a keyboard, mouse, keypad, touch pad, turn-wheel, and the like), a fixed storage 2014 (such as a hard drive, flash storage, and the like), a removable media component 2016 (operable to control and receive a solid-state memory device, an optical disk, a flash drive, and the like), a network interface 2018 (operable to communicate with one or more remote devices via a suitable network connection), and a speaker 2020 (to output an audible communication). In some embodiments the input interface 2012 and the display 2010 can be combined, such as in the form of a touch screen.

The bus 2002 can allow data communication between the central processor 2004 and one or more memory components 2014, 2016, which can include RAM, ROM, or other memory. Applications resident with the computing device 2000 generally can be stored on and accessed via a computer readable storage medium.

The fixed storage 2014 can be integral with the computing device 2000 or can be separate and accessed through other interfaces. The network interface 2018 can provide a direct connection to the premises management system and/or a remote server via a wired or wireless connection. The network interface 2018 can provide such connection using any suitable technique and protocol, including digital cellular telephone, WiFi™, Thread®, Bluetooth®, near field communications (NFC), and the like. For example, the network interface 2018 can allow the computing device 2000 to communicate with other components of the premises management system or other computers via one or more local, wide-area, or other communication networks.

The foregoing description, for purpose of explanation, has been described with reference to specific configurations. However, the illustrative descriptions above are not intended to be exhaustive or to limit configurations of the disclosed technologies to the precise forms disclosed. Many modifications and variations are possible in view of the above teachings. The configurations were chosen and described in order to explain the principles of configurations of the disclosed technologies and their practical applications, to thereby enable others skilled in the art to utilize those configurations as well as various configurations with various modifications as may be suited to the particular use contemplated.

1. A method for reducing instances of inclusion of data associated with hindsight bias in a training set of data for a machine learning system, the method comprising:
receiving, by a processor, a first set of data, the first set of data organized as records, the records having a first set of fields;
performing, by the processor, an analysis of data in a first field of the first set of fields with respect to data in a second field of the first set of fields, wherein the second field corresponds to an occurrence of an event;
determining, by the processor, a result of the analysis, the result being that the data in the first field is associated with hindsight bias;
producing, by the processor and in response to the result, a second set of data, the second set of data organized as the records, the records having a second set of fields, wherein the second set of fields includes the first set of fields except the first field;
generating, by the processor and in response to a production of the second set of data, at least one feature associated with the second set of data;
producing, by the processor and in response to a generation of the at least one feature, a third set of data, the third set of data organized as the records, the records having a third set of fields, wherein the third set of fields includes the second set of fields and at least one additional field, wherein the at least one additional field corresponds to the at least one feature;
producing, by the processor and using the third set of data, the training set of data; and
causing, by the processor and using the training set of data, the machine learning system to be trained to predict an outcome of a future occurrence of the event.

2. The method of claim 1, wherein:
the third set of data uses a first number of memory cells;
a fourth set of data uses a second number of memory cells;
the fourth set of data is organized as the records, the records having a fourth set of fields, wherein the fourth set of fields includes the first set of fields and the at least one additional field; and
the first number is less than the second number.

3. The method of claim 1, further comprising:
determining, by the processor and for the first set of data, a first set of records, wherein members of the first set of records have a value of the second field that is other than a null value;
designating, by the processor, a preliminary training set of data, wherein the preliminary training set of data includes the first set of records; and
designating, by the processor, a scoring set of data, wherein the scoring set of data includes the records other than the first set of records.

4. The method of claim 3, wherein the performing the analysis comprises:
determining, for the preliminary training set of data, a second set of records, wherein members of the second set of records have a value of the first field that is other than a null value; and
determining, for the scoring set of data, that all of the members of the scoring set of data have the value of the first field that is the null value.

5. The method of claim 3, wherein the performing the analysis comprises:
determining, for the preliminary training set of data, a second set of records, wherein members of the second set of records have a value of the first field that is other than a null value;
determining a first quotient, the first quotient being of a count of the members of the second set of records divided by a count of members of the preliminary training set of data;
determining, for the scoring set of data, a third set of records, wherein members of the third set of records have the value of the first field that is other than the null value;
determining a second quotient, the second quotient being of a count of the members of the third set of records divided by a count of the members the scoring set of data;
determining that the first quotient is less than or equal to a threshold; and
determining that the second quotient is less than or equal to the threshold.

6. The method of claim 3, wherein the performing the analysis comprises:
determining, for the preliminary training set of data, a second set of records, wherein members of the second set of records have a value of the first field that is other than a null value;
determining a first quotient, the first quotient being of a count of the members of the second set of records divided by a count of members of the preliminary training set of data;
determining, for the scoring set of data, a third set of records, wherein members of the third set of records have the value of the first field that is other than the null value;
determining a second quotient, the second quotient being of a count of the members of the third set of records divided by a count of the members the scoring set of data; and
determining that an absolute value of a difference between the second quotient subtracted from the first quotient is greater than or equal to a threshold.

7. The method of claim 1, wherein the performing the analysis comprises:
determining a set of records, wherein members of the set of records have a value of the first field that is other than a null value; and
determining, for the set of records, that a value of the second field of one record of the set of records is a same as a value of the second field of each other record of the set of records.

8. The method of claim 1, wherein the performing the analysis comprises:
determining a set of records, wherein members of the set of records have a value of the second field of one record of the set of records that is a same as a value of the second field of each other record of the set of records;
determining a first count, the first count being of the members of the set of records;
determining, for the set of records, a subset of the set of records, wherein a value of the first field of each member of the subset of the set of records is other than a null value;
determining a second count, the second count being of members of the subset of the set of records; and
determining that an absolute value of a difference between the second count subtracted from the first count is less than or equal to a threshold.

9. The method of claim 1, wherein the performing the analysis comprises:
determining a set of records, wherein members of the set of records have a value of the second field of one record of the set of records that is a same as a value of the second field of each other record of the set of records; and
determining that a value of the first field of each member of the set of records is a null value.

10. The method of claim 1, wherein the performing the analysis comprises:
determining a set of records, wherein members of the set of records have a value of the second field of one record of the set of records that is a same as a value of the second field of each other record of the set of records;
determining a first count, the first count being of the members of the set of records;
determining, for the set of records, a subset of the set of records, wherein a value of the first field of each member of the subset of the set of records is a null value;
determining a second count, the second count being of members of the subset of the set of records; and
determining that an absolute value of a difference between the second count subtracted from the first count is less than or equal to a threshold.

11. The method of claim 1, wherein the performing the analysis comprises:
determining a first set of records, wherein a value of the first field of one record of the first set of records is a same as a value of the first field of each other record of the first set of records;
determining a second set of records, the second set of records being the records other than the first set of records; and
determining, for the second set of records, that a value of the second field of one record of the second set of records is a same as a value of the second field of each other record of the second set of records.

12. The method of claim 1, wherein the performing the analysis comprises:
determining a first set of records, wherein a value of the first field of one record of the first set of records is a same as a value of the first field of each other record of the first set of records;
determining a second set of records, the second set of records being the records other than the first set of records;
determining a first count, the first count being of members of the second set of records;
determining, for the second set of records, a superset of the second set of records, wherein a value of the second field of one record of the superset of the second set of records is a same as a value of the second field of each other record of the superset of the second set of records;
determining a second count, the second count being of members of the superset of the second set of records; and
determining that an absolute value of a difference between the first count subtracted from the second count is less than or equal to a threshold.

13. The method of claim 1, wherein the performing the analysis comprises:
determining a set of records, wherein members of the set of records have a value of the second field of one record of the set of records that is a same as a value of the second field of each other record of the set of records; and
determining, for the set of records, that a value of the first field of one record of the set of records is a same as a value of the first field of each other record of the set of records.

14. The method of claim 1, wherein the performing the analysis comprises:
determining a set of records, wherein members of the set of records have a value of the second field of one record of the set of records that is a same as a value of the second field of each other record of the set of records;
determining a first count, the first count being of the members of the set of records;
determining, for the set of records, a subset of the set of records, wherein a value of the first field of one record of the subset of the set of records is a same as a value of the first field of each other record of the subset of the set of records;
determining a second count, the second count being of members of the subset of the set of records; and
determining that an absolute value of a difference between the second count subtracted from the first count is less than or equal to a threshold.

15. The method of claim 1, wherein the producing the training set of data comprises:
selecting, from the third set of data, a set of features; and
selecting a mathematical model for the machine learning system.

16. The method of claim 1, wherein the causing the machine learning system to be trained comprises conveying, to another processor, the training set of data, the training set of data to be used by the other processor to train the machine learning system to predict the outcome of the future occurrence of the event.

17. The method of claim 1, wherein the causing the machine learning system to be trained comprises training, using the training set of data, the machine learning system to predict the outcome of the future occurrence of the event.

18. The method of claim 17, further comprising:
tracking, by the processor, in iterations, and in response to the machine learning system having been trained, actual outcomes of occurrences of the event;
determining, by the processor and for a set of iterations, a set of quotients, wherein a quotient, of the set of quotients, is a first count divided by a second count, the first count being of the actual outcomes, for an iteration of the set of iterations, that are a specific actual outcome, the second count being of all the actual outcomes for the iteration;
determining, by the processor and for the set of quotients, an average of the quotients;
determining, for the set of iterations, a set of differences, a difference, of the set of differences, being, for the iteration, an absolute value of the quotient subtracted from the average of the quotients;
determining, from the set of differences, a set of unusual actual outcomes, wherein the absolute value of members of the set of unusual actual outcomes is greater than or equal to a threshold; and
excluding, by the processor, the records associated with the set of unusual actual outcomes from a future training set of data.

19. A non-transitory computer-readable medium storing computer code for reducing instances of inclusion of data associated with hindsight bias in a training set of data for a machine learning system, the computer code including instructions to cause the processor to:
receive a first set of data, the first set of data organized as records, the records having a first set of fields;
perform an analysis of data in a first field of the first set of fields with respect to data in a second field of the first set of fields, wherein the second field corresponds to an occurrence of an event;
determine a result of the analysis, the result being that the data in the first field is associated with hindsight bias;
produce, in response to the result, a second set of data, the second set of data organized as the records, the records having a second set of fields, wherein the second set of fields includes the first set of fields except the first field;
generate, in response to a production of the second set of data, at least one feature associated with the second set of data;
produce, in response to a generation of the at least one feature, a third set of data, the third set of data organized as the records, the records having a third set of fields, wherein the third set of fields includes the second set of fields and at least one additional field, wherein the at least one additional field corresponds to the at least one feature;
produce, using the third set of data, the training set of data; and
cause, using the training set of data, the machine learning system to be trained to predict an outcome of a future occurrence of the event.

20. A system for reducing instances of inclusion of data associated with hindsight bias in a training set of data for a machine learning system, the system comprising:
a memory configured to store a first set of data, a second set of data, a third set of data, and the training set of data; and
a processor configured to:
receive the first set of data, the first set of data organized as records, the records having a first set of fields;
perform an analysis of data in a first field of the first set of fields with respect to data in a second field of the first set of fields, wherein the second field corresponds to an occurrence of an event;
determine a result of the analysis, the result being that the data in the first field is associated with hindsight bias;
produce, in response to the result, the second set of data, the second set of data organized as the records, the records having a second set of fields, wherein the second set of fields includes the first set of fields except the first field;
generate, in response to a production of the second set of data, at least one feature associated with the second set of data;
produce, in response to a generation of the at least one feature, the third set of data, the third set of data organized as the records, the records having a third set of fields, wherein the third set of fields includes the second set of fields and at least one additional field, wherein the at least one additional field corresponds to the at least one feature;
produce, using the third set of data, the training set of data; and
cause, using the training set of data, the machine learning system to be trained to predict an outcome of a future occurrence of the event.
